(19) United States
(12) Patent Application Publication
(10) Pub. No.: US 2017/0087957 A1
(43) Pub. Date: Mar. 30, 2017

(54) HYBRID VEHICLE WITH MULTI-ZONE CABIN COOLING AND INTEGRATED BATTERY COOLING

(71) Applicant: FORD GLOBAL TECHNOLOGIES, LLC, DEARBORN, MI (US)

(72) Inventors: TIMOTHY N. BLATCHLEY, DEARBORN, MI (US); KEN J. JACKSON, DEARBORN, MI (US); ANGEL F. PORRAS, DEARBORN, MI (US)

(21) Appl. No.: 14/863,576

(22) Filed: Sep. 24, 2015

(51) Int. Cl. B60H 1/00; B60H 1/32

(52) U.S. Cl. CPC B60H 1/00278; B60H 1/00392; B60H 1/321; B60H 1/323; B60H 2001/3255; B60H 2001/3266; B60H 2001/3272

(57) ABSTRACT

Cooling of a battery pack of an electrified vehicle is performed with an optimized energy usage and with minimal impact on cooling of the passenger cabin. Refrigerant from a condenser in an air conditioning system is evaporated in a front evaporator to cool a main air flow in a front cabin zone. The refrigerant is evaporated in a coolant chiller to cool a liquid coolant. The liquid coolant is pumped from the chiller to a rear exchanger to cool a rear air flow in a rear cabin zone. The liquid coolant is pumped from the chiller to the battery when a battery temperature and an ambient air temperature correspond to an active cooling mode. The coolant is pumped between the battery and a passive radiator instead of the chiller when the battery coolant temperature and the ambient air temperature correspond to a passive cooling mode.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to battery cooling in electrified vehicles, and, more specifically, to a liquid-cooled battery with active and passive cooling modes.

When an electrical storage battery (e.g., battery pack) is used to provide power to an electric motor to drive an electrified vehicle (e.g., hybrid electric or full electric), the temperature of the battery can increase when the motor is operating for extended periods of time. The battery pack is usually installed in a relatively small, enclosed space which tends to retain the heat generated. Increases in battery temperature can reduce battery charge efficiency and impede battery performance. If the battery is not cooled, the power generation, battery life, and fuel economy may suffer.

Passenger vehicles typically have a passenger air conditioning system to actively cool the passenger compartment, including a compressor, a refrigerant line, a condenser, and a heat exchanger such as an evaporator. One way that high battery temperatures have been addressed is to use at least a portion of the passenger compartment air conditioning system to cool the battery. Because the air conditioning system is used to cool the passenger compartment, the same compressor can be used to cool the battery, with an additional refrigerant line and evaporator. U.S. Pat. No. 7,658,083 discloses a shared cabin/battery cooling system wherein an evaporator core is provided for cooling the battery via air circulated by a battery fan across the evaporator core and the battery.

In order to more effectively cool the battery, liquid cooling systems have been introduced because liquid coolant can circulate through a cold plate in contact with the battery cells to remove the heat. The liquid coolant can convey the heat to a battery chiller which shares the refrigerant of the passenger air conditioning system.

Another trend in passenger air conditioning systems is the use of separately cooled zones (e.g., front seating and rear seating zones) within the passenger cabin. Each zone may have a respective evaporator which is individually coupled to the refrigerant circuit for on-demand cooling of air in the respective zone. In an electrified vehicle with multiple passenger cooling zones, the demand on the shared refrigerant supply subsystem can become large. Increasing the size of shared cooling subsystem components (e.g., compressor, condenser, evaporator) can be undesirable due to losses in efficiency and increases in cost. Thus, it would be desirable to optimize performance of and energy use by the chiller and evaporators to reduce the overall size of the A/C components while balancing cooling system operation to best meet performance targets when the separate cooling sections reach their peak demands.

As the number of evaporators grows and the needed capacity of other air conditioning components is increased, additional problems can arise such as increased compressor oil entrapment, more costly and complex refrigerant distribution, and difficulty balancing peak consumption for different sections of the A/C system. Therefore, it would be desirable to simplify the refrigerant-based cooling system and reduce the number of evaporators.

### SUMMARY OF THE INVENTION

Since liquid cooling of the battery pack of a hybrid or other electrified vehicle is desirable, a refrigerant-to-coolant heat exchanger (i.e., a chiller) is used in order to provide active cooling of the battery when necessary. In order to reduce the need for refrigerant-based evaporators, the present invention uses the coolant from the chiller to also provide cooling for the rear zone of the passenger cabin using a coolant-to-air heat exchanger (i.e., a cooling core). Additionally, the invention provides a passive cooling mode for the battery which is used whenever conditions permit. In one aspect of the invention, an electrified vehicle comprises a shared cooling subsystem including a compressor and a condenser circulating a refrigerant. A main evaporator is selectably coupled to the shared cooling subsystem and adapted to evaporate refrigerant to cool a main air flow in a main section of a passenger cabin of the vehicle. A coolant chiller is selectably coupled to the shared cooling subsystem and adapted to evaporate refrigerant to cool a liquid coolant. A chiller pump pumps the coolant from the chiller. A zone exchanger selectably receives coolant from the chiller pump to cool a zone air flow in a zone of the passenger cabin. A battery pack providing electrical energy for propelling the vehicle, wherein the battery pack includes an internal conduit for conveying the coolant. A passive radiator is exposed to an ambient air temperature. A battery pump pumps the coolant through the internal conduit. A diverting valve has a first configuration establishing a first circulation loop including the radiator, the battery pump, and the internal conduit, and has a second configuration establishing a second circulation loop including the chiller and the internal conduit.

### BRIEF DESCRIPTION OF THE DRAWINGS

FIG. 1 is a block diagram of a conventional electrified vehicle.

FIG. 2 is a block diagram of a prior art cooling system for a passenger cabin and a battery pack of an electrified vehicle.

FIG. 3 is a block diagram showing an embodiment of a shared cabin/battery cooling system of the present invention wherein the battery is being passively cooled.

FIG. 4 is a block diagram showing the cooling system of FIG. 3 wherein the battery is being actively cooled.

FIG. 5 is a graph showing regimes for active and passive battery cooling according to one embodiment of the invention.

FIG. 6 is a flowchart showing an embodiment of a method of the invention.

FIG. 7 is a block diagram showing another embodiment of a shared cabin/battery cooling system of the present invention with an alternative pump arrangement, wherein the battery is being actively cooled.

FIG. 8 is a block diagram of the cooling system of FIG. 7 wherein the battery is being passively cooled.

FIG. 9 is a block diagram showing another embodiment of a shared cabin/battery cooling system of the present invention with another alternative pump arrangement.

### DETAILED DESCRIPTION OF PREFERRED EMBODIMENTS

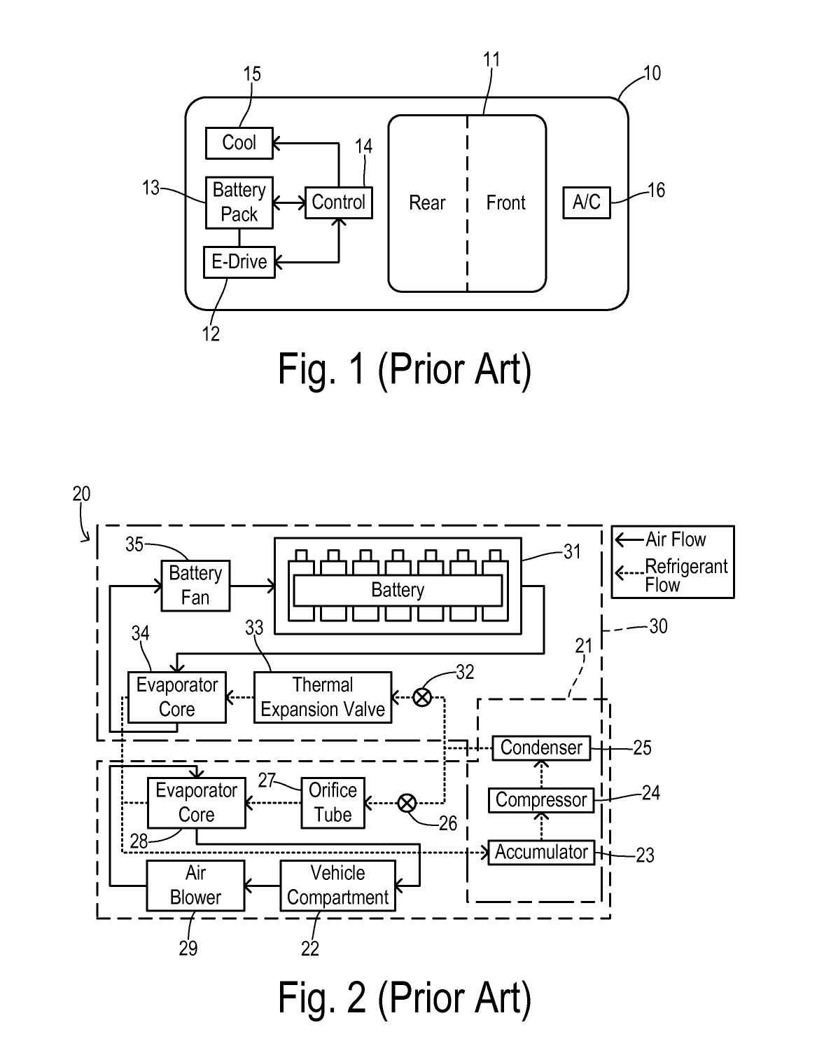

Referring to FIG. 1, an electrified vehicle 10 has a passenger cabin 11 with front and rear zones as indicated. An electric drive 12 (e.g., an inverter-driven traction motor) receives electrical power from a battery pack 13. A controller 14 may include a battery control module for monitoring battery performance (including battery temperature) and a system controller for operating the inverter. A battery cooling system 15 provides a cooling fluid (such as a chilled liquid coolant or a cooled air flow) to battery pack 13 under control of controller 14. Conventional systems have utilized an independent source of cooled air in cooling system 15 and have used a shared cooling system with a passenger A/C system 16 (for either air-cooled or liquid-cooled batteries).

FIG. 2 shows a prior art shared cooling system 20 including a passenger compartment air conditioning (A/C) system 21 capable of cooling passenger compartment 22. The passenger compartment A/C system 21 includes an accumulator 23, a compressor 24, a condenser 25, a shutoff valve 26, an expansion device 27 (such as an expansion valve or an orifice tube), and an evaporator core 28. These elements are configured to allow a refrigerant to flow between them and operate in a manner known in the art. The flow of refrigerant is determined in part by shutoff valve 26.

Passenger compartment A/C system 21 also includes an air blower 29 operable to facilitate air flow between evaporator core 28 and vehicle compartment 22. Cooling system 20 also includes a battery A/C subsystem 30 capable of cooling a battery 31. Battery A/C subsystem 30 includes a shutoff valve 32, a thermal expansion valve 33, and an evaporator core 34.

Battery A/C subsystem 30 shares accumulator 23, compressor 24, and condenser 25 with the passenger compartment A/C system 21. These elements are configured to allow a refrigerant to flow between them and operate in a manner known in the art. The flow of refrigerant between thermal expansion valve 33 and evaporator core 34 is determined by shutoff valve 32. Battery A/C subsystem 30 also includes a battery fan 35 operable to facilitate air flow between battery 31 and evaporator core 34.

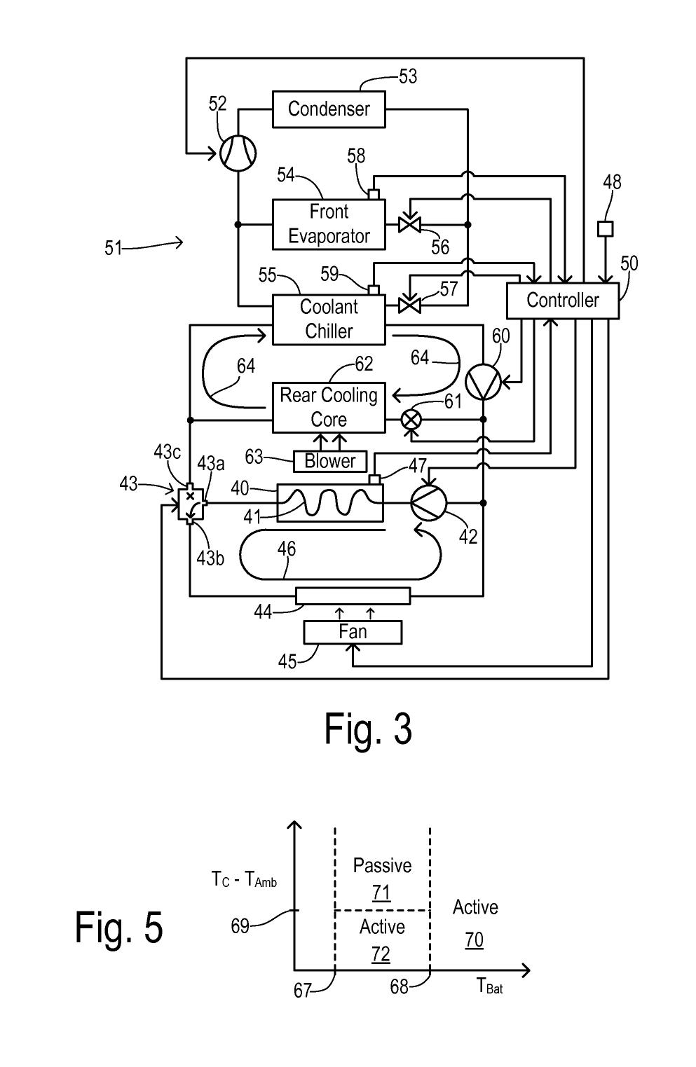

FIG. 3 shows one preferred embodiment of the invention wherein an electrified vehicle having a battery pack 40 for providing electrical energy to an electric drive. Battery 40 includes a conduit 41 for conveying a liquid coolant that absorbs heat from battery 40 and then releases it in one of either an active or passive cooling mode as described below. Conduit 41 may pass through a cold plate which contacts the battery cells, for example.

A battery pump 42 circulates the coolant through a coolant circuit including a plurality of coolant lines interconnecting internal conduit 41, a three-way diverter valve 43, and a passive battery radiator 44. Diverter valve has an inlet 43a receiving coolant from battery conduit 41 and can be set by a controller 50 to couple inlet 43a to either outlet 43b or outlet 43c. In the position shown in FIG. 3, outlet 43b is selected which results in a passive cooling mode with a flow indicated by arrow 46 (i.e., the air conditioning system is not used for cooling the battery). Passive radiator 44 may include a battery fan 45 for increasing heat removal as coolant passes through radiator 44. Fan 45 is also controlled by controller 50 (e.g., based on coolant temperature). A temperature sensor 47 provides a battery temperature signal T_{Bat} to controller 50. Controller 50 may include dedicated logic circuits, programmable gate arrays, or a programmable general-purpose microcontroller, for example. Battery temperature T_{Bat} corresponds to a battery core temperature, but inlet and outlet temperatures of the coolant may also be sensed. An ambient air temperature sensor 48 is mounted to the vehicle where it is exposed to outside air. Controller 50 uses battery temperature T_{Bat} and ambient air temperature T_{Amb}, respectively, in determining when to activate the passive or active cooling modes as described below.

A refrigerant-based air conditioning subsystem 51 circulates a refrigerant ii) from a compressor 52 to an outside heat exchanger (OHX) 53 operating as a condenser. Refrigerant is supplied through expansion valves 56 and 57 to a front (main) evaporator 54 and coolant chiller 55, respectively. Front evaporator 54 is a refrigerant-to-air heat exchanger for serving a main cabin zone such as the front passenger cabin. Coolant chiller 55 is a refrigerant-to-coolant heat exchanger that chills coolant to be utilized for rear seat cooling and/or battery cooling. Valves 56 and 57 may be electronic expansion valves (EXV) that are wired for receiving control signals from controller 50. EXV 57 in particular is able to be completely closed in order to avoid any consumption of refrigerant by chiller 55 when not being used. Temperature sensors 58 and 59 incorporated in evaporator 54 and chiller 55, respectively, are coupled to the controller 50 for closed-loop temperature control as known in the art.

A coolant outlet from chiller 55 is coupled to a chiller pump 60 for pumping chilled coolant to be used in parallel for cooling the rear cabin zone and/or the battery. Thus, coolant from chiller pump 60 can be selectively coupled through a shutoff valve 61 to a rear cooling core 62 (which is a coolant-to-air heat exchanger). When cooling of the rear zone is demanded, valve 61 is opened and a blower 63 is activated by controller 50 to provide a coolant flow as shown by arrows 64. Core 62 and blower 63 may be installed in a rear air handling unit, for example.

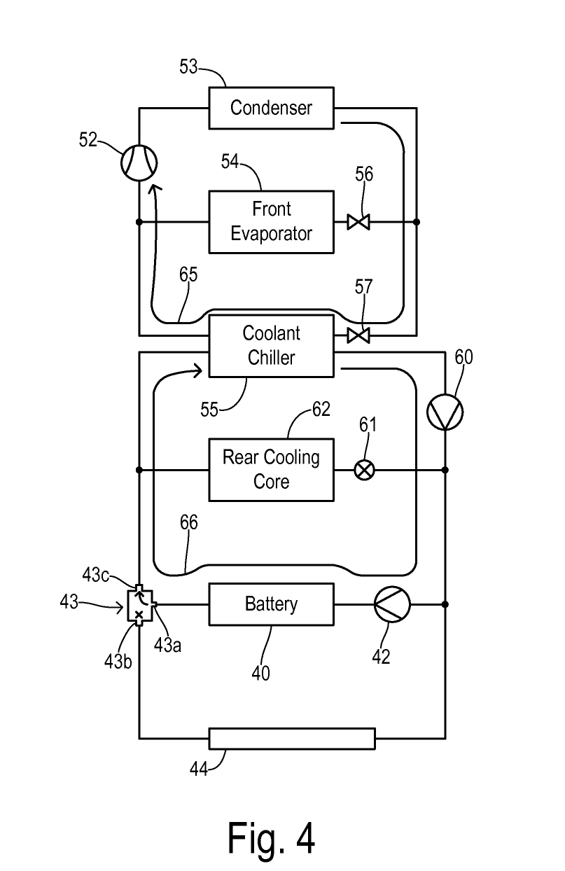

In order to cool the battery in an active cooling mode, controller 50 configures diverter valve 43 so that inlet 43a is coupled to outlet 43c as shown in FIG. 4. Thus, coolant from chiller 55 is directed by pumps 60 and 42 through battery 40 in a loop shown by arrow 66. Simultaneously, refrigerant is circulated in a loop 65 through expansion valve 57 and chiller 55 to remove heat from the coolant. In this mode, pump 42 acts as a booster pump. When battery 40 is being cooled in an active cooling mode, cooling of the rear cabin zone using cooling core 62 can be either on or off. Chiller 55 is sized for handling normal cooling loads for the battery and rear zone simultaneously. Refrigerant flow rates through expansion valves 56 and 57 are modulated by controller 50 in response to respective temperature signals to control the superheat of each component in a manner known in the art. The use of electronic expansion valves (EXVs) achieves a fine level of control of refrigerant consumption so that usage by the chiller does not inadvertently exceed the necessary level because any unnecessary loss (i.e., waste) of overall cooling capacity could have a negative impact on cabin cooling. Instead of an EXV, a thermostatic expansion valve (TXV) in series with a shutoff valve could be used.

In operation, the battery cooling system in FIG. 3 uses a minimum of energy as a result of 1) using passive cooling whenever possible and 2) by imposing strict control of refrigerant used by the battery chiller once active cooling becomes required. FIG. 5 illustrates some temperature relationships for defining active and passive cooling regimes used by the battery cooling system. Selection of active or passive cooling modes may be determined by measured battery temperature T_{Bat} and ambient temperature T_{Amb} and comparing with various temperature thresholds. Another battery-related temperature which may be used in the control algorithm is a measured temperature of the coolant T_{C} as it exits the battery cold plate. A first threshold T₁ shown at 67 defines a lowest battery temperature at which cooling of the battery pack becomes desired (e.g., about 10° C.). A power-limiting threshold T_{PL} shown at 68 is a lowest battery temperature at which electrical output from the battery pack is negatively impacted to the degree that it becomes worthwhile to expend more energy to reduce the battery temperature (e.g., about 40° C.). Thus, when battery temperature T_{Bat} is greater than power-limiting temperature T_{PL} then the battery cooling system enters the active cooling mode in active regime 70 (i.e., the controller issues command signals to position the diverter valve to circulate liquid coolant from the battery internal conduit through the chiller and to open the expansion valve feeding refrigerant to battery chiller).

When battery temperature T_{Bat} is greater than first threshold T₁ and less than power-limiting temperature T_{PL} then the selection of the cooling mode depends on a difference between battery coolant temperature T_{C} and ambient air temperature T_{Amb}. This difference is a measure of the ability of the passive radiator to transfer heat to the ambient environment. A difference threshold T_{Diff} shown at 69 represents the temperature difference that is needed for successful cooling. If the actual difference is greater than T_{Diff} then the battery cooling system enters the passive cooling mode in passive regime 71 (i.e., the controller issues command signals to position the diverter valve to circulate liquid coolant from the battery cooling conduit through the radiator). In addition, the controller may activate the battery fan (e.g., based on another temperature threshold). If the actual difference is less than T_{Diff} then the battery cooling system enters the active cooling mode in active regime 72 (i.e., the controller issues command signals to position the diverter valve to circulate liquid coolant from the battery conduit through the coolant chiller and to open the expansion valve feeding refrigerant to the chiller).

A typical air-conditioning system may utilize a variable speed compressor wherein the compressor speed is set according to the cooling load (which is usually determined by a temperature measured at the evaporator output). In the present invention, it is necessary to arbitrate the determination of the compressor speed due to the existence of multiple refrigerant evaporators (i.e., the front evaporator and the chiller) which may or may not all operate simultaneously. In order to maintain acceptable cabin cooling performance without adding excess complexity to the control system, the present invention employs a priority scheme for selecting an evaporator temperature to use in determining compressor speed. Thus, the controller sets the compressor speed according to a temperature of the front evaporator at all times when it is cooling the passenger cabin. During times that the coolant chiller is the only element actively being used to evaporate refrigerant, then the compressor speed is set by the controller according to a temperature of the chiller output.

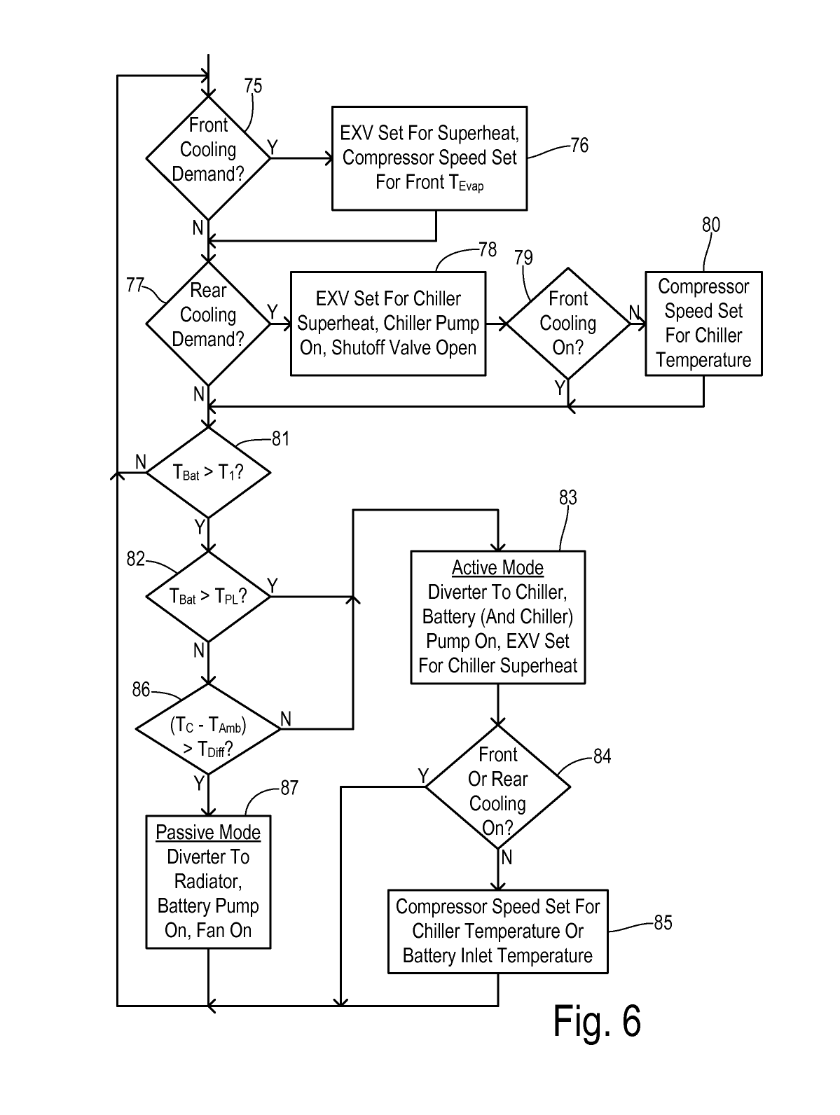

FIG. 6 shows a preferred method of the invention for shared cooling of the passenger cabin and the battery pack of an electrified vehicle. Initially, the cooling system is assumed to be off (e.g., with expansion valves Closed). In step 75, a check is performed to determine whether an operator demand is present for front cooling. If so, then the expansion valve for the front evaporator is set to Open and refrigerant flow is modulated to provide the desired superheat for the evaporator in step 76. In addition, the compressor speed is set according to a temperature of the front evaporator. After responding to the demand or a lack of a demand for front cooling, a check is performed in step 77 to determine whether there is a demand for rear zone cooling. If there is a demand for rear cooling, then the expansion valve for the coolant chiller is set to Open and is modulated to provide the desired superheat at the chiller outlet in step 78. The chiller pump is turned on and the shutoff valve, if any, leading to the rear cooling core is set to Open. A check is performed in step 79 to determine whether front cooling is already turned on (i.e., whether the compressor temperature is being controlled according to the front T_{Evap}). If not turned on, then the compressor speed is set in step 80 according to the chiller temperature. Otherwise, the compressor speed continues to be controlled according to the front evaporator temperature.

After handling the front and rear cooling demands, battery cooling is addressed. In step 81, a check is performed to determine whether battery temperature T_{Bat} is greater than a first temperature threshold T₁. If not, then a return is made to step 75 since no battery cooling is needed. Otherwise, a check is performed in step 82 to determine whether battery temperature T_{Bat} is greater than power limiting temperature T_{PL}. If the result is yes, then an active cooling mode for the battery is entered at step 83 wherein i) the diverter valve is set to route coolant to the chiller, and ii) pumping of the coolant to the battery is initiated (e.g., the battery pump is turned on and the chiller pump is turned on if not already on). The expansion valve for the chiller is set to Open if it is not already Open because of a rear cooling demand (and the chiller expansion valve continues to be modulated according to a chiller temperature to provide the desired amount of superheat). In step 84, a check is performed to determine whether either the front or rear cooling is already on (i.e., if one of those is controlling the compressor speed). If they are not, then compressor speed is set in step 85 according to the chiller temperature (or, alternatively, according to a battery coolant inlet temperature). Then a return is made to step 75.

In the event that battery temperature T_{Bat} is not greater than power limiting temperature T_{PL} in step 82, then a check is performed in step 86 to determine whether a difference between a battery-related temperature (preferably the coolant temperature at the outlet of the battery T_{C}) and ambient temperature is greater than a threshold difference T_{Diff}. If not, then the active cooling mode is entered in step 83. Otherwise, a passive cooling mode for the battery is entered in step 87 wherein the diverter valve is set to route coolant to the radiator, the battery pump is turned on, and the fan is turned on for drawing air over the radiator if desired.

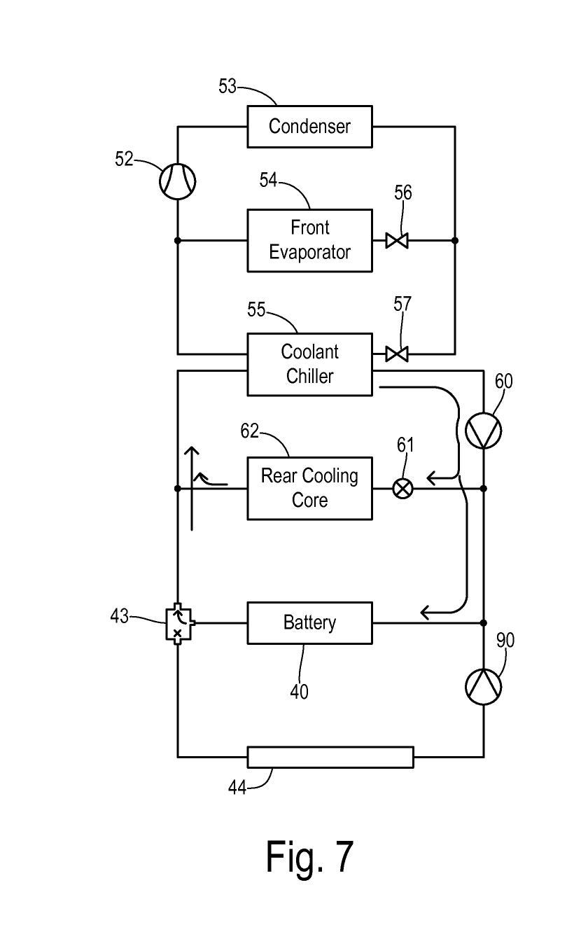

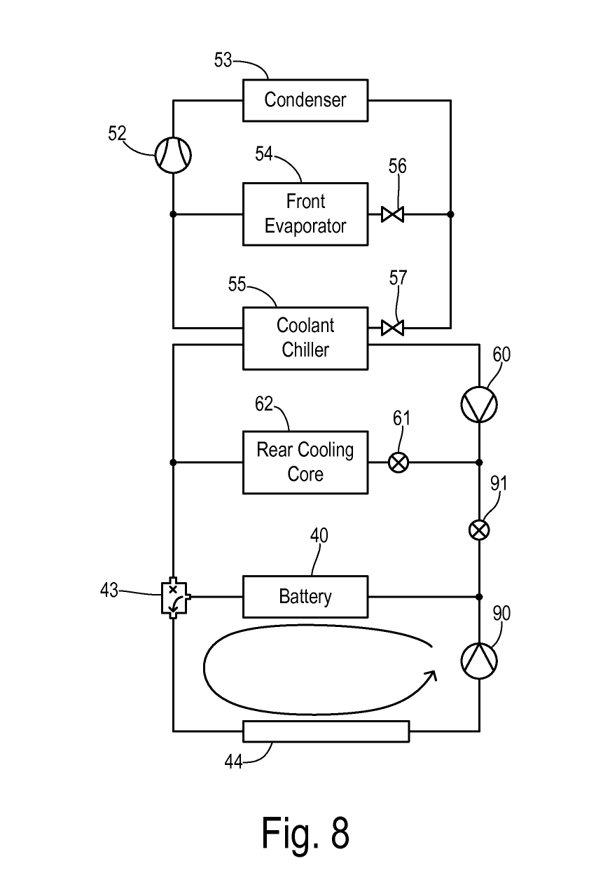

FIG. 7 shows an alternative arrangement for the coolant pumps. Chiller pump 60 provides all of the pumping action for both rear cooling core 62 and battery 40 when operating in the active battery cooling mode. No booster pump is present for the active mode. Instead, a battery pump 90 is placed between radiator 44 and battery 40 in order to pump coolant only when in the passive cooling mode. FIG. 7 shows diverter valve 43 set for the active cooling mode, with the flow from chiller pump 60 being shared between battering battery cooling and rear zone cooling. FIG. 8 shows diverter valve 43 switched to the passive cooling mode wherein battery pump 90 provides a flow only within a loop including battery 40 and radiator 44. If desired, an isolation valve 91 may be provided between the outlets from pumps 60 and 90 if necessary to obtain sufficient isolation when operating in the passive cooling mode.

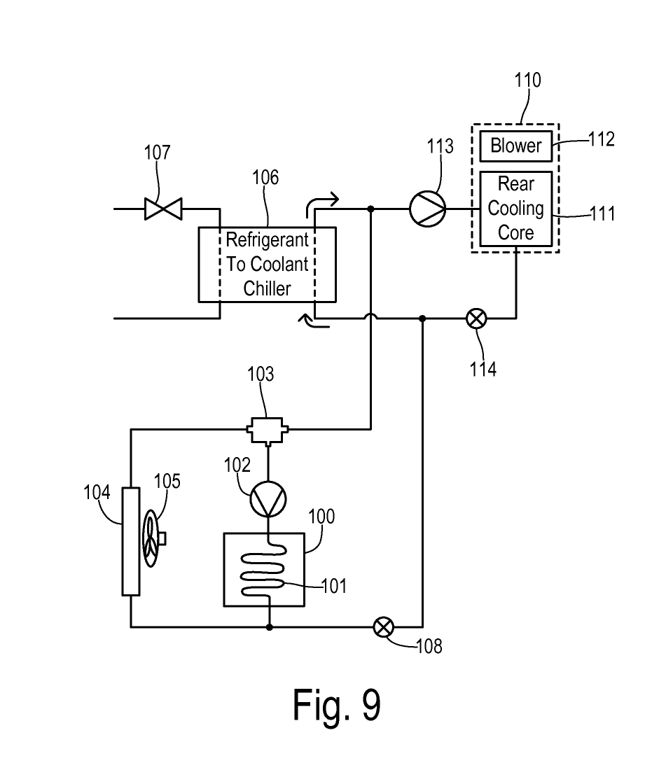

FIG. 9 shows an alternative embodiment wherein the rear cabin zone cooling and battery cooling functions utilize separate pumps. Thus, a battery 100 includes an internal conduit 101 for receiving coolant from a battery pump 102. Diverter valve 103 can feed coolant to the input of battery pump 102 from a radiator 104 when operating in a passive mode or from a chiller 106 when operating in an active cooling mode. Again, a fan 105 may be arranged in conjunction with radiator 104.

Refrigerant-to-coolant chiller 106 receives refrigerant from an expansion valve 107 on one side and circulates a cooled coolant on the other side. Coolant from chiller 106 can be pumped to battery conduit 101 by battery pump 102 via diverter valve 103 independently from coolant use by a rear zone cooling section. A shutoff valve 108 can be connected between the coolant outlet from battery 100 and an inlet to chiller 106 if necessary to obtain isolation between the parallel active cooling loops.

For rear zone cooling, an air handling unit 110 may include a rear cooling core 111 and a blower 112. Cooling core 111 receives coolant from a rear cabin pump 113, and a shutoff valve 114 may be provided between core 111 and chiller 106 to is isolate the rear cabin zone if necessary.

What is claimed is:

1. An electrified vehicle comprising:
a shared cooling subsystem including a compressor and a condenser circulating a refrigerant;
a main evaporator selectably coupled to the shared cooling subsystem and adapted to evaporate refrigerant to cool a main air flow in a main section of a passenger cabin of the vehicle;
a coolant chiller selectably coupled to the shared cooling subsystem and adapted to evaporate refrigerant to cool a liquid coolant;
a chiller pump for pumping the coolant from the chiller;
a zone exchanger selectably receiving coolant from the chiller pump to cool a zone air flow in a zone of the passenger cabin;
a battery pack providing electrical energy for propelling the vehicle, wherein the battery pack includes an internal conduit for conveying the coolant;
a passive radiator exposed to an ambient air temperature;
a battery pump for pumping the coolant through the internal conduit; and
a diverting valve with a first configuration establishing a first circulation loop including the radiator, the battery pump, and the internal conduit, and with a second configuration establishing a second circulation loop including the chiller and the internal conduit.

2. The vehicle of claim 1 further comprising:
battery sensors sensing a battery temperature and a battery coolant temperature; and
a controller providing commands to the valve for selecting one of the configurations, wherein when the battery temperature is between a first threshold temperature and a predetermined power-limiting temperature then commanding the first configuration provided that a difference between the battery coolant temperature and the ambient temperature is greater than a predetermined difference and otherwise commanding the second configuration, and wherein when the battery temperature is greater than the power-limiting temperature then commanding the second configuration.

3. The vehicle of claim 1 wherein the internal conduit of the battery is connected to receive coolant from the chiller in parallel with the zone exchanger.

4. The vehicle of claim 1 wherein the chiller pump is further connected to pump coolant to the internal conduit of the battery, and wherein the vehicle further comprises a shutoff valve for selectably isolating the zone exchanger from the chiller pump.

5. The vehicle of claim 1 wherein the battery pump is configured to pump coolant from either the chiller or the radiator.

6. The vehicle of claim 1 further comprising an electric fan selectably activated to blow air over the radiator when the diverting valve is in the first configuration.

7. The vehicle of claim 1 wherein the compressor is a variable speed compressor, wherein the controller sets a speed of the compressor according to a temperature of the main evaporator at all times when the main evaporator cools the passenger cabin, and wherein the controller sets a speed of the compressor according to a temperature of the chiller during times that refrigerant is being evaporated by only the chiller.

8. A method to cool a battery and cabin zones in an electrified vehicle, comprising:
cooling a front cabin zone using a front evaporator;
chilling a liquid coolant using a chiller to cool a rear cabin zone;
selecting between passively cooling the battery using a battery radiator or actively cooling the battery by circulating the chilled coolant to the battery depending on battery-related temperatures and an ambient air temperature.

9. A method to cool a battery and cabin zones in an electrified vehicle, comprising:
providing a refrigerant from a condenser in an air conditioning system;
evaporating the refrigerant in a front evaporator to cool a main air flow in a front cabin zone;
evaporating the refrigerant in a coolant chiller to cool a liquid coolant;
pumping the coolant from the chiller to a rear exchanger to cool a rear air flow in a rear cabin zone;
pumping the coolant from the chiller to the battery when a battery temperature and an ambient air temperature correspond to an active cooling mode; and
pumping coolant between the battery and a passive radiator instead of the chiller when a battery coolant temperature and the ambient air temperature correspond to a passive cooling mode.

10. The method of claim 9 wherein:
the active cooling mode is selected when the battery temperature is above a predetermined power-limiting temperature;
the passive cooling mode is selected when the battery temperature is between a first threshold and a power-limiting temperature of the battery if a difference between the battery coolant temperature and the ambient air temperature is greater than a predetermined difference; and
the active cooling mode is selected when the battery temperature is between the first threshold and the power-limiting temperature if the difference between the battery coolant temperature and the ambient air temperature is less than the predetermined difference.
